(19) United States
(12) Patent Application Publication
(10) Pub. No.: US 2020/0048124 A1
(43) Pub. Date: Feb. 13, 2020

(54) SYSTEM AND METHOD FOR CLOSED-LOOP DISSOLVED OXYGEN MONITORING AND CONTROL

(71) Applicant: Cube Hydro Partners, LLC, Bethesda, MD (US)

(72) Inventors: Walter Neal Simmons, Bahama, NC (US); Connor James Tinen, Brooklyn, NY (US)

(21) Appl. No.: 16/454,039

(22) Filed: Jun. 26, 2019

Related U.S. Application Data
(60) Provisional application No. 62/690,343, filed on Jun. 26, 2018.

(51) Int. Cl. C02F 7/00; F03B 15/06; F03B 17/00

(52) U.S. Cl. CPC C02F 7/00; C02F 2103/34; F03B 17/005; F03B 15/06

(57) ABSTRACT

A computer-implemented method of closed-loop dissolved oxygen monitoring and control at a hydroelectric plant includes: regulating at least one aeration valve coupled to a turbine using pattern recognition; wherein a target parameter for the regulating is a dissolved oxygen concentration of water downstream of the hydroelectric plant. The dissolved oxygen concentration may be at least 5.0 milligrams per liter. The pattern recognition may be performed using a neural network.

### CROSS-REFERENCE TO RELATED APPLICATION

This application claims the benefits of U.S. Provisional Application No. 62/690,343 filed Jun. 26, 2018 by Walter Neal Simmons and Connor James Tinen and entitled “System and Method for Closed-Loop Dissolved Oxygen Monitoring and Control” under 35 U.S.C. § 119(e) and the entire contents of that application are expressly incorporated herein by reference thereto.

### FIELD OF THE INVENTION

The invention relates to closed-loop dissolved oxygen monitoring and control. More particularly, the invention relates to monitoring and control of aeration systems configured to adjust dissolved oxygen concentrations in bodies of water such as downstream of an impoundment. In addition, the invention relates to monitoring dissolved oxygen concentrations and controlling the air intake of an aerating turbine to achieve desired dissolved oxygen concentrations in water flowing through a turbine and released downstream of an impoundment. Further, the invention relates to active feedback control of an aerating system of a turbine.

### BACKGROUND OF THE INVENTION

Hydroelectric power is an important source of renewable energy. According to the U.S. Energy Information Administration, in 2016, about 6.5% of the total utility-scale electricity generation in the United States was from hydropower, corresponding to 44% of the total utility-scale electricity generation from all renewable energy sources.

The general operation of a hydroelectric dam is straightforward. To generate electrical power, water from the impoundment (e.g., the reservoir) flows through an intake proximate the bottom of the dam (near the water floor), and is conducted through a penstock (e.g., a conduit or pipe) to the blades of a turbine (e.g., the runners or propeller). As the blades are quickly turned, so too is the turbine generator shaft. That shaft is coupled to the rotor of a generator that rotates with respect to the generator's stator to produce power. Finally, as water flows past the turbine blades, it is conducted through a tailrace (e.g., a channel) so as to be carried away from the dam.

Among its many upsides, hydropower doesn't pollute the air, it promotes “energy independence” by virtue of being domestically produced, and it contributes to the stability of the grid because its inherent storage capacity can be quickly tapped to respond to increases in electricity demand.

Despite offering many advantages, however, the use of dams has raised concerns because of their potential ecological influence, specifically their potential impact on water quality. Organic materials such as algal blooms and other organic debris can become concentrated in the water confined by a dam, especially due to limited circulation of that water. While some organic debris can be removed from the impoundment, it is not practical to remove it all. As bacteria decompose the materials, the microorganisms undesirably can consume a disproportionate share of the dissolved oxygen otherwise present in the water and critical to sustaining water-based life such as fish and aquatic insects. Complicating matters, a temperature differential commonly develops between water toward the surface and water toward the floor of the impoundment. The thermal stratification is known to create a warmer region or layer toward the surface (a.k.a. the epilimnion) and a comparatively colder region or layer toward the bottom (a.k.a. the hypolimnion). It is the hypolimnion that can become particularly oxygen-deprived, with the concentration of dissolved oxygen even potentially decreasing to a level as low as 1 milligram per liter (which is 1 part per million (ppm)).

The oxygen-poor hypolimnion can present challenges to hydropower operators, for example, if the desired dissolved oxygen concentration downstream of the hydroelectric plant is at least 6.0 milligrams per liter (6 ppm). For example, Title 15A (Environmental Quality) of the North Carolina Administrative Code (NCAC) assigns classifications and water quality standards to surface waters and wetlands in the state. “Class C” freshwaters are defined in 15A NCAC 02B.0101(c)(1) as “freshwaters protected for secondary recreation, fishing, aquatic life including propagation and survival, and wildlife. All freshwaters shall be classified to protect these uses at a minimum.” As for “fresh surface water standards for Class C waters,” 15A NCAC 02B.0211(6) requires: “Dissolved oxygen: not less than 6.0 mg/l for trout waters; for non-trout waters, not less than a daily average of 5.0 mg/l with a minimum instantaneous value of not less than 4.0 mg/l; swamp waters, lake coves, or backwaters, and lake bottom waters may have lower values if caused by natural conditions.”

Because the intake of a hydroelectric dam is typically disposed in the hypolimnion, water ultimately released through the tailrace can be less oxygenated (and colder) than desired. Operators of hydroelectric plants desire to proactively mitigate any potential impacts “below the dam,” such as in the tailwater immediately downstream of the dam. Thus, there exists a need to address the issue of undesirably low dissolved oxygen concentrations in water discharged from dams.

A variety of technologies exist for aerating water at a hydroelectric dam. For example, a motorized blower or air compressor may be employed to actively introduce air into water in the turbine or draft tube. Such a design, however, suffers again from a loss of efficiency (which would vary as a function of the required motor horsepower but could be in the range of 1-5%) and shear cost including maintenance.

Another known active technology employs an oxygen tank and evaporators coupled to perforated hosing disposed in the hypolimnion (upstream of the turbine). The hosing delivers oxygen gas to the water through the perforations which release oxygen bubbles.

Yet another known active design for aerating the discharge water involves the injection of liquid oxygen. The shear ongoing expense, however, prevents this option from being adopted in mainstream applications. Additionally, there are significant safety concerns associated with storing, handling, and using liquid oxygen.

As another active option, pumps may be used to transport surface water from the epilimnion down to the dam's intakes to mix with water from the hypolimnion so that water with a higher average dissolved oxygen concentration enters the turbine for subsequent discharge from the dam. Such pumps must be powerful enough to transport a substantial amount of water and the capital costs for installation are quite significant.

In contrast to the aforementioned active design modifications, numerous passive technologies are known. For example, so-called auto-venting turbine technology draws atmospheric air into the operating turbine to aerate the discharge water flow. In one design known as distributed aeration, air is drawn through pipes disposed above the turbine's head cover and flows into the water through slots on the discharge edges of hollow runner blades. In another design known as central aeration, air is drawn from above the turbine's head cover either through the hollow interior of the turbine shaft or around the sides of the turbine's deflector before being introduced into the water. In yet another design known as peripheral aeration, air is drawn through a manifold system proximate the draft tube (which is disposed at the exit of the turbine and is connected to the tailrace) and is introduced into the water through a slot or orifices on the inside surface of the cone portion of the draft tube. While certainly increasing dissolved oxygen levels, such auto-venting designs unfortunately suffer from several disadvantages including a loss of operating efficiency (for example, by 2-4%) and increased costs because they are not standard features of hydroelectric turbines.

Another option for aerating water employs the turbine's vacuum breaker system, which draws air proximate the turbine runners when a vacuum is induced. For example, baffles may be added to vacuum breaker air discharge ports in either the turbine runner's crown or nose cone and the vacuum breaker may be locked in an open state to allow air to continue to flow. Alternatively, a bypass conduit may be added to the vacuum breaker to add ventilation to the head cover. Again, however, these designs unfortunately suffer from several disadvantages including a loss of operating efficiency (for example, by 2%) and increased costs because they are not standard features of certain hydroelectric turbines.

U.S. Patent Application Publication No. 2016/0327012 A1 to Beaulieu discloses an aerating system for the runner of a hydraulic turbine. The runner has a plurality of blades, such that inter-blade canals are configured between each pair of blades for the admission of air in the water flow circulating through the hydraulic turbine. At least one hydrofoil is located in the inter-blade canal of the runner contacting the pair of blades.

Another passive means, an aerating weir, is used to reaerate turbine discharges that are oxygen poor. The weir essentially acts as a waterfall; water is oxygenated as it falls over the edge of the weir. Such weirs are downstream of the turbine. Unfortunately, weirs suffer from cost and safety issues. As to the latter, they present obstacles to users of the waterway.

Finally, fixed cone valves (also known as Howell-Bunger valves, free discharge valves, or ring jet valves) may be installed in dams as a means of aerating water discharged from impoundments. Because of the discharge profile of water released from such valves, in the form of an expanding conical jet, a substantial flow surface contacts surrounding atmosphere at variable but controllable rates, interacting with and entraining air to thereby oxygenate the water. In effect, an aerated spray is created, exiting the valve commonly at either 45 degrees (e.g., if a cone with a 90-degree cone angle is used) or 30 degrees as measured with respect to an axis extending perpendicular from the pipe. The body of the valve typically comprises a central, conical deflector head proximate the downstream end, internal radial ribs, and a mounting flange proximate the upstream end. A valve gate is provided in the form of a cylinder that slides over the valve body, and the valve typically is operated using a mechanical screw stem actuating system or hydraulic cylinders. The gate is a telescoping sleeve that regulates water flow. In the valve, water flows around the central cone and is discharged at high pressure.

Despite the aforementioned known technologies for aerating water released from an impoundment, there exists a need for other aeration solutions.

### SUMMARY OF THE INVENTION

A method for closed-loop dissolved oxygen monitoring and control at a hydroelectric plant includes: regulating at least one aeration valve coupled to a turbine with a neural net, wherein a target parameter for the regulating is a dissolved oxygen concentration of water downstream of the hydroelectric plant. The dissolved oxygen concentration may be at least 6.0 milligrams per liter (6 ppm).

A computer-implemented method of closed-loop dissolved oxygen monitoring and control at a hydroelectric plant includes: regulating at least one aeration valve coupled to a turbine using pattern recognition; wherein a target parameter for the regulating is a dissolved oxygen concentration of water downstream of the hydroelectric plant. In some embodiments, the dissolved oxygen concentration may be at least 5.0 milligrams per liter or at least 6.0 milligrams per liter. In some embodiments, the pattern recognition may be performed using a neural network. The regulating may set a degree of opening the at least one aeration valve. The pattern recognition may include at least one machine learning algorithm, and in some embodiments the at least one machine learning algorithm may be provided with data inputs including at least one of: (a) dissolved oxygen concentration, water level, and water temperature upstream of the hydroelectric plant; (b) dissolved oxygen concentration, water level, and water temperature downstream of the hydroelectric plant; (c) unit power output and quality; (d) required dissolved oxygen concentration; (e) atmospheric temperature and humidity; and (f) time of day and day of year.

The method may further include: analyzing the data inputs using a four layer, four output neural network that outputs an optimal valve position of each of four intake air valves that minimizes efficiency loss while ensuring the hydroelectric plant satisfies the target parameter.

The hydroelectric plant may include a plurality of turbines and the pattern recognition may be performed using a single neural network for each turbine. In another embodiment, the hydroelectric plant may include a plurality of turbines and the pattern recognition may be performed using a single neural network for at least two of the plurality of turbines.

In some embodiments, the at least one aeration valve may include a plurality of runner blades of the turbine. In some embodiments, the at least one aeration valve may discharge air via through-blade aeration of the turbine. The at least one aeration valve may discharge air via a passage within at least one runner blade of the turbine. Also, the at least one aeration valve may discharge air through a crown portion of the turbine. The at least one aeration valve may discharge air via central aeration of the turbine. In some embodiments, the at least one aeration valve may discharge air via (a) through-blade aeration of the turbine and (b) central aeration of the turbine.

A computer-implemented method of closed-loop dissolved oxygen monitoring and control at a hydroelectric plant includes: using closed-loop control to regulate at least one aeration valve coupled to a turbine and at least one cone valve coupled to a water-retaining structure of the hydroelectric plant; wherein a target parameter for the regulating is a dissolved oxygen concentration of water downstream of the hydroelectric plant. The dissolved oxygen concentration may be at least 5.0 milligrams per liter or at least 6.0 milligrams per liter. The closed-loop control may include pattern recognition performed using a neural network, and the pattern recognition may include at least one machine learning algorithm. The closed-loop control may be used to set a degree of opening the at least one aeration valve. Also, in some embodiments, the closed-loop control may be used to set a degree of opening the at least one cone valve.

The closed-loop control may be provided with data inputs including at least one of: (a) dissolved oxygen concentration, water level, and water temperature upstream of the hydroelectric plant; (b) dissolved oxygen concentration, water level, and water temperature downstream of the hydroelectric plant; (c) unit power output and quality; (d) required dissolved oxygen concentration; (e) atmospheric temperature and humidity; and (f) time of day and day of year. The method may further include: analyzing the data inputs using a four layer, four output neural network that outputs an optimal valve position of each of four intake air valves that minimizes efficiency loss while ensuring the hydroelectric plant satisfies the target parameter.

In some embodiments, the hydroelectric plant may include a plurality of turbines and the closed-loop control may be performed using a single neural network for each turbine. In some embodiments, the hydroelectric plant may include a plurality of turbines and the closed-loop control may be performed using a single neural network for at least two of the plurality of turbines. The at least one aeration valve include a plurality of runner blades of the turbine. The at least one aeration valve may discharge air via through-blade aeration of the turbine. The at least one aeration valve may discharge air via a passage within at least one runner blade of the turbine. Also, in some embodiments, the at least one aeration valve may discharge air through a crown portion of the turbine. The at least one aeration valve may discharge air via central aeration of the turbine. In some embodiments, the at least one aeration valve may discharge air via (a) through-blade aeration of the turbine and (b) central aeration of the turbine. The at least one cone valve may include a fixed cone valve and/or a linear aerating valve.

A computer-implemented method of closed-loop dissolved oxygen monitoring and control at a hydroelectric plant comprising a turbine, the method including: regulating at least one aeration valve coupled to a turbine by at least one machine learning algorithm; wherein a target parameter for the regulating is a dissolved oxygen concentration of water downstream of the hydroelectric plant. The at least one machine learning algorithm may include a neural network. In some embodiments, the dissolved oxygen concentration may be at least 5.0 milligrams per liter or at least 6.0 milligrams per liter.

A non-transitory computer-readable medium having computer readable instructions that, when executed by a processor of a computer, cause the computer to perform closed-loop dissolved oxygen monitoring and control at a hydroelectric plant that includes: regulating at least one aeration valve coupled to a turbine using pattern recognition; wherein a target parameter for the regulating is a dissolved oxygen concentration of water downstream of the hydroelectric plant. The dissolved oxygen concentration may be at least 5.0 milligrams per liter or at least 6.0 milligrams per liter. In some embodiments, the pattern recognition may be performed using a neural network.

A system includes: a processor; memory including instructions that when executed by the processor, cause the system to perform closed-loop dissolved oxygen monitoring and control at a hydroelectric plant that includes: regulating at least one aeration valve coupled to a turbine using pattern recognition; wherein a target parameter for the regulating is a dissolved oxygen concentration of water downstream of the hydroelectric plant. The dissolved oxygen concentration may be at least 5.0 milligrams per liter or at least 6.0 milligrams per liter. The pattern recognition may be performed using a neural network.

### BRIEF DESCRIPTION OF THE DRAWINGS

Preferred features of the inventions are disclosed in the accompanying drawing, wherein:

FIG. 1 is a schematic showing operation of a neural net for setting valve position.

### DETAILED DESCRIPTION OF THE PREFERRED EMBODIMENTS

In an exemplary embodiment, closed-loop dissolved oxygen monitoring and control is applied with respect to the High Rock Development located in Davie, Davidson, and Rowan counties, North Carolina on the Yadkin River and opened in 1927. The reservoir is impounded by a 936-foot-long, 101-foot-high dam that comprises (1) a 58-foor long non-overflow section, (2) a 550-foot-long gated spillway section with ten 45-foot-wide by 30-foot-high stoney gates, (3) a 178-foot-long, 125-foot-high powerhouse intake, and (4) a 150-foot-long non-overflow section. The concrete powerhouse is integral with the dam and comprises three vertical Francis turbine/generator units with a total installed capacity of 32.91 MW.

In the exemplary embodiment, it is desired that the dissolved oxygen concentration downstream of the High Rock hydroelectric plant is at least 6.0 milligrams per liter (6 ppm). For example, Title 15A (Environmental Quality) of the North Carolina Administrative Code (NCAC) assigns classifications and water quality standards to surface waters and wetlands in the state. “Class C” freshwaters are defined in 15A NCAC 02B.0101(c)(1) as “freshwaters protected for secondary recreation, fishing, aquatic life including propagation and survival, and wildlife. All freshwaters shall be classified to protect these uses at a minimum.” As for “fresh surface water standards for Class C waters,” 15A NCAC 02B.0211(6) requires: “Dissolved oxygen: not less than 6.0 mg/l for trout waters; for non-trout waters, not less than a daily average of 5.0 mg/l with a minimum instantaneous value of not less than 4.0 mg/l; swamp waters, lake coves, or backwaters, and lake bottom waters may have lower values if caused by natural conditions.”

Thus, for regulatory, environmental, and compliance reasons, operators of dams such as High Rock may need to install and operate equipment to adjust the dissolved oxygen content of water that passes through their facilities.

In order to monitor dissolved oxygen, sensor units for example may be mounted to floats positioned downstream of the dam, with each of the sensor units having a power supply that may include solar cells and batteries, as well as temperature and dissolved oxygen sensors, and a control system for capturing and reporting relevant data. For example, the sensor units preferably are wireless. Each float may be provided with a programmable logic controller (PLC) which is coupled to a cellular modem that transmits sensor data to a server.

In the exemplary embodiment, in order to meet dissolved oxygen targets at High Rock, controllable valve intake openings are provided with respect to the aerating runners of the turbines. The runners, which rely on the natural creation of a vacuum below the turbine (as water passes through), use the vacuum to pull negative pressure on the headcover of the turbine. The water passing through the turbine incorporates air, of course with oxygen, that is supplied through the runners. The water then is released into the reservoir below, thereby improving dissolved oxygen concentrations below the dam.

An exemplary aerating system for the runner of a hydraulic turbine that may be adapted for dissolved oxygen monitoring and control is disclosed in U.S. Patent Application Publication No. 2016/0327012 A1 to Beaulieu, which is incorporated in its entirety herein by reference.

By varying the degree of opening of the valve intakes, operators may vary in a precise manner how much air (with oxygen) is incorporated into the water passing through the turbines, in furtherance of meeting dissolved oxygen requirements.

The incorporation of dissolved oxygen in the water expelled from the impoundment downstream of the dam, however, can present issues. For example, the disruption and the turbulence induced in the water flow may reduce the efficiency of the turbines and reduce the maximum power output of the facility. Accordingly, the system and method closed-loop dissolved oxygen monitoring and control preferably is operated in a manner that facilitates efficiency. In other words, it is desirable to ensure effective oxygenation of water expelled from the impoundment while minimizing impacts upon turbine operation and power generation.

Given a set of hydrological conditions upstream of the dam (e.g., current dissolved oxygen concentration, water level, and temperature), a set of hydrological conditions downstream of the dam (e.g., required or desired dissolved oxygen concentration, current dissolved oxygen concentration, water level, and temperature), and a set of desired power characteristics (e.g., power output, power quality, and turbine units in operation), an optimal amount of oxygen intake may be set to meet dissolved oxygen requirements while minimizing impacts upon efficiency. The system and method thus may receive data from in-stream dissolved oxygen sensors upstream and downstream of the dam (e.g., both in the stream and at the dam such as in the intake and draft tube) and use that data along with required or desired dissolved oxygen concentrations, and desired unit power output, and then determine the appropriate air intake valve openings.

In one exemplary embodiment, the degree of opening the air intake valves may be determined by machine learning algorithm(s). For example, a neural network may be provided with data including: upstream reservoir dissolved oxygen concentration, water level, and temperature; downstream reservoir dissolved oxygen concentrations, water level, and temperature; unit power outputs and qualities; required dissolved oxygen concentration; atmospheric temperature, and humidity; and the time of day and day of the year. In a preferred exemplary embodiment, these inputs may be taken into a four layer, four output neural network that outputs the optimal valve position of each of four intake air valves that minimizes efficiency loss while ensuring the dam satisfies mandated or desired dissolved oxygen targets.

The control parameter—the air intake valve position—is the independent variable that is adjusted.

In some embodiments, air temperature (a climate predictor) may be used to predict changes in water temperature.

In some embodiments, data analyzed to determine how much to open/close the air intake valves may be limited based on the degree of influence of a particular condition on the overall determination. For example, data for air temperature and humidity may not be used in some embodiments.

In some embodiments, the target parameter—the required or desired dissolved oxygen concentration is at least 6.0 milligrams per liter (6 ppm). When a neural network is “trained,” for example, this target parameter becomes particularly relevant.

For example, a valve may be opened 50% while achieving 5.8 milligrams per liter (5.8 ppm) dissolved oxygen concentration in water downstream of the dam. Comparing that concentration to the target, a greater amount of valve opening may be needed to achieve at least 6.0 milligrams per liter (6 ppm).

In a preferred embodiment, the process parameter is the dissolved oxygen concentration downstream of the dam, which preferably is actual data collected from the water downstream of the dam (e.g., 6.4 ppm or 5.8 ppm). The process parameter represents what the control parameter is adjusted to control. In addition, auxiliary parameters may help predict how the system and method may perform, and include, for example, temperature of air (which may only have a small effect on the calculations, but may help predict how much oxygen will be taken up at what rate), humidity or relative humidity (which also may only have a small effect on the calculations, but may serve as a climate predictor and may influence the amount of oxygen the water will take up), the temperature of the water downstream and upstream of the dam (which impacts the solubility of oxygen in water), dissolved oxygen content upstream, the amount of power desired to be generated, the quality of power (e.g., how much reactive power is produced), head levels upsteam and downstream (e.g., the level of the water, such as depth of the reservoir/impoundment, head water elevation and tail water elevation) which may influence turbine performance (e.g., the larger the difference between those elevations, the more energy may be generated because the energy is a function of the difference between those elevations), the time of day (e.g., dissolved oxygen levels bottom out at nighttime at least in part because plant life in the water is not photosynthesizing and producing oxygen), and the day of the year (e.g., there are seasonal differences in how dissolved oxygen concentration changes, for example because water temperature changes so slowly that the season is a big predictor of water behavior).

For example, at 9:00 p.m. at night, turbine valve(s) used for aeration may need to be further opened because photosynthesis is not occurring and thus dissolved oxygen levels in downstream water may be low and thus need to be increased.

In some embodiments, additional parameter(s) (data) may include dissolved oxygen concentrations downstream of additional dam(s) that may be above or below the system in operation, such as a second dam downstream of the first dam.

In some embodiments, other data that may be provided for use in determining the degree of valve opening/closing includes, for example, rain fall (actual or predicted), barometric pressure, and inflows of rivers upstream (e.g., using gauges/sensors on such rivers upstream for providing data concerning the flow of water coming downstream).

The system and method disclosed herein advantageously permits operators to better manage the aeration of water while still permitting desired power to be generated. In other words, as stated previously, the performance of the turbine may be impacted by the amount of aeration that is occurring. For example, the operator may start generating 12 MW, but then open valve(s) to provide aeration and the resulting drop in efficiency may decrease the power production to 11.2 MW.

In some embodiments, aeration is provided by bubbling air in the impoundment and without any aeration using a turbine.

Turbine efficiency curves may indicate efficiency dependent on (1) flow through the turbine and net head which is (2) headwater elevation minus (3) tailwater elevation. Both flow and net head may be nonlinear.

For aerating turbines, a fourth dimension may be added: air intake, which also may be nonlinear. Thus, operation of the hydroelectric plant may be based on three independent variables (flow, head, and air intake) and one dependent variable (power output, e.g., efficiency).

In the preferred embodiment, the process and auxiliary parameters are fed into a neural network and it outputs the control parameters which correspond to the position of each of the air intake valves (e.g., four valves) of the turbine.

Preferably, the neural net is run on a computer while other components are controlled by PLCs. For example, at least one PLC reports all of the input parameters to the computer, and the computer then reports control parameters back to the PLC. The PLC then adjusts those control parameters. Then, the PLC reports a new set of input and process parameters to the computer and the sequence is repeated.

The system and method resembles a classic proportional-integral-derivative (PID) controller loop, but differs because machine learning (which is predictive) is leveraged.

Preferably, the neural net is trained and “supervised learning” is utilized. The target dissolved oxygen concentration (e.g., a continuous value) downstream of the dam is known, so control is needed to achieve that target.

In one exemplary embodiment, the loop (sequence) is repeated every 30 seconds. In another exemplary embodiment, the loop (sequence) is repeated every 60 seconds. In yet another exemplary embodiment, the loop (sequence) is repeated every 60 minutes.

Various other types of machine learning algorithms may be used, such as Almeida-Pineda recurrent backpropagation, ALOPEX, backpropagation, bootstrap aggregating, CN2 algorithm, constructing skill trees, Dehaene-Changeux model, diffusion map, dominance-based rough set approach, dynamic time warping, error-driven learning, evolutionary multimodal optimization, expectation—maximization algorithm, FastICA, forward—backward algorithm, GeneRec, Genetic Algorithm for Rule Set Production, growing self-organizing map, HEXQ, hyper basis function network, IDistance, K-nearest neighbors algorithm, kernel methods for vector output, kernel principal component analysis, Leabra, Linde-Buzo-Gray algorithm, local outlier factor, logic learning machine, LogitBoost, manifold alignment, minimum redundancy feature selection, mixture of experts, multiple kernel learning, non-negative matrix factorization, online machine learning, out-of-bag error, prefrontal cortex basal ganglia working memory, PVLV, Q-learning, quadratic unconstrained binary optimization, query-level feature, Quickprop, radial basis function network, randomized weighted majority algorithm, reinforcement learning, repeated incremental pruning to produce error reduction (RIPPER), Rprop, rule-based machine learning, skill chaining, Sparse PCA, state-action-reward-state-action, stochastic gradient descent, Structured kNN, T-distributed stochastic neighbor embedding, temporal difference learning, wake-sleep algorithm, and weighted majority algorithm (machine learning).

Machine learning methods that may be used include, but are not limited to, instance-based algorithm (e.g., K-nearest neighbors algorithm (KNN), Learning vector quantization (LVQ), Self-organizing map (SOM)), regression analysis (e.g., logistic regression, Ordinary least squares regression (OLSR), linear regression, stepwise regression, and multivariate adaptive regression splines (MARS)), regularization algorithm (e.g., ridge regression, Least Absolute Shrinkage and Selection Operator (LASSO), elastic net, and Least-angle regression (LARS)), and classifiers (e.g., probabilistic classifier, Naive Bayes classifier, binary classifier, linear classifier, and hierarchical classifier).

In some alternate embodiments, machine learning is not used. Rather, a PID loop or other control algorithm is used.

The system and method disclosed herein also may be applied to dams used in agricultural and flood control that don't produce power, or to processing plants.

Preferably, five core variables are used in the system and method disclosed herein: desired power output of a single plant as well as dissolved oxygen content of water and temperature of water both upstream and downstream. In another embodiment, for example, seven core variables may include: desired power output of each of three unit in a plant as well as dissolved oxygen content of water and temperature of water both upstream and downstream.

In one embodiment, a neural net is created for operating one unit, i.e. one turbine. However, the plant may have multiple turbines which are not all running at the same power output, because they may not all be on (e.g., sometimes the operator only wants to generate a small amount of power because either that is all that can be sold, there is a maintenance outage, there is a lack of water, the price dictates the decision, or regulatory requirements). In some embodiments, a unit may be substantially always operated. In one example, the outputs of neural nets from a unit 1 and a unit 3 may be used as an input to a unit 2. In another example, if units 1 and 3 are always online and valves are open to provide full aeration, and unit 2 is just being brought online, it may not be necessary to open valves for unit 2 as much or at all because units 1 and 3 are already achieving the desired aeration. However, an optimization may be performed for distributing aeration maximally efficiently across the units.

Typically, the less aeration the turbine is providing, the more efficient it is.

In addition, a neural net on unit 2 may be used to predict how open the valves are on units 1 and 3 because units 1 and 3 will perform in some repeatable fashion over time. Thus, another auxiliary parameter that may be used is the power generated (e.g., real power) or power quality on other generating units.

In one embodiment, a single neural net is provided for each turbine. In another embodiment, a single neural net is provided for multiple turbines (such as units 1, 2, and 3). An advantage based on a single unit is that individual neural nets adapt to the peculiarities of each turbine—the net tunes to that turbine. Sometimes in a plant, the turbines are different types, and/or have different aeration systems, power ratings, and retrofitting or rebuilds.

Preferably, the valves used for aeration are motorized to permit operator adjustment. In addition, preferably the valves are analog so that they may be continuously controlled with respect to how open or closed the valve may be set. Preferably, the valves provide a linear relationship between flow as a function amount of openness of valve (desired openness).

The system and method disclosed herein improves upon the practice of most operators to keep the aeration valves 100% open (or some other fixed value), so they are potentially adding more oxygen than necessary to meet desired DO levels and decreasing the efficiency of power generation.

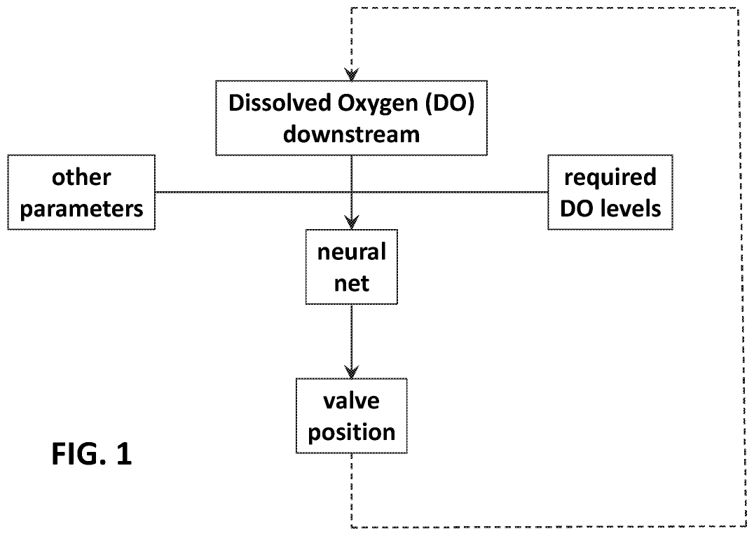

A schematic showing operation of an exemplary neural net for setting valve position is shown in FIG. 1.

In an exemplary embodiment, the algorithm is provided with 24 data points. The dissolved oxygen concentration is determined one hour after the algorithm is run, and then the valve openness is adjusted. The algorithm may set the valve openness at 12:00 a.m., and then at 1:00 a.m. account for the then-current dissolved oxygen concentration and adjust the valve openness. This sequence may be repeated every hour, nominally for a day over some range of values that are preselected. The algorithm may sweep the entire range of the valve. The 24 data points may be used at the start, and then backpropagation may be used based on the 24 values, determining a best guess as to each of the weights (multipliers) of each unit in the neural network, and then the algorithm may operate over the next 24 hours without intervention. Then, data may again be collected and the algorithm may be retrained based on 48 data points. The algorithm may be retrained every day for some period of time, or alternatively the most recent period of data (e.g., 10 years) may be retained. In one preferred embodiment, at least 10 data points are retained for each day of the year.

In alternate embodiments, instead of day of the year, the month of the year is used, or the day and the month of the year are used.

In one exemplary neural net, two hidden layers are used at the outset.

The output layer may have 4 units or as many units as there are aeration devices to be controlled.

An exemplary embodiment has 20 input units and four output units (one for each of four valves). Alternatively, if there are six valves, then there are six output units.

In one embodiment, all valves are controlled with one output unit. However, in another embodiment, in order to get more granularity (e.g., more efficient outcomes), each valve is controlled with its own output unit.

In one embodiment, IFM Efector, Inc. model TT1291 (TT-150KFED06-/US/) temperature sensors are used. Also, in one embodiment, In-Situ Inc. Rugged Dissolved Oxygen (RDO) PRO-X optical dissolved oxygen probes are used.

The embodiments herein optionally may be presented as including individual functional blocks including functional blocks comprising devices, device components, steps or routines in a method embodied in software, or combinations of hardware and software.

In some embodiments the computer-readable storage devices, mediums, and memories for use in connection with the embodiments herein may include a cable or wireless signal containing a bit stream and the like. However, when mentioned, non-transitory computer-readable storage media expressly exclude media such as energy, carrier signals, electromagnetic waves, and signals per se.

Methods in accordance with the embodiments herein may be implemented using computer-executable instructions that are stored or otherwise available from computer readable media. Such instructions may comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods in accordance with the embodiments herein include, but are not limited to, magnetic or optical disks, flash memory, USB devices provided with non-volatile memory, and networked storage devices.

Devices implementing methods in accordance with the embodiments herein may comprise hardware, firmware and/or software, and may take any of a variety of form factors including, but not limited to, laptops, smart phones, small form factor personal computers, personal digital assistants, rackmount devices, and standalone devices. Functionality described herein also can be embodied in peripherals or add-in cards and may be implemented on a circuit board among different chips or different processes executing in a single device, for example.

The instructions, media for conveying such instructions, computing resources for executing them, and other structures for supporting such computing resources are means for providing the functions described herein.

While various descriptions of the inventions are described above, it should be understood that the various features can be used singly or in any combination thereof. Therefore, the inventions are not to be limited to only the specifically preferred embodiments depicted or otherwise described herein.

Further, it should be understood that variations and modifications within the spirit and scope of the inventions may occur to those skilled in the art to which the inventions pertain. Accordingly, all expedient modifications readily attainable by one versed in the art from the disclosure set forth herein that are within the scope and spirit of the inventions are to be included as further embodiments of the inventions. The scope of the inventions is accordingly defined as set forth in the appended claims.

What is claimed is:

1. A computer-implemented method of closed-loop dissolved oxygen monitoring and control at a hydroelectric plant comprising:
regulating at least one aeration valve coupled to a turbine using pattern recognition;
wherein a target parameter for the regulating is a dissolved oxygen concentration of water downstream of the hydroelectric plant.

2. The method of claim 1, wherein the dissolved oxygen concentration is at least 5.0 milligrams per liter.

3. The method of claim 1, wherein the pattern recognition is performed using a neural network.

4. The method of claim 1, wherein the regulating sets a degree of opening the at least one aeration valve.

5. The method of claim 1, wherein the pattern recognition comprises at least one machine learning algorithm.

6. The method of claim 5, wherein the at least one machine learning algorithm is provided with data inputs including at least one of:
(a) dissolved oxygen concentration, water level, and water temperature upstream of the hydroelectric plant;
(b) dissolved oxygen concentration, water level, and water temperature downstream of the hydroelectric plant;
(c) unit power output and quality;
(d) required dissolved oxygen concentration;
(e) atmospheric temperature and humidity; and
(f) time of day and day of year.

7. The method of claim 6, further comprising:
analyzing the data inputs using a four layer, four output neural network that outputs an optimal valve position of each of four intake air valves that minimizes efficiency loss while ensuring the hydroelectric plant satisfies the target parameter.

8. The method of claim 1, wherein the hydroelectric plant comprises a plurality of turbines and the pattern recognition is performed using a single neural network for each turbine.

9. The method of claim 1, wherein the hydroelectric plant comprises a plurality of turbines and the pattern recognition is performed using a single neural network for at least two of the plurality of turbines.

10. The method of claim 1, wherein the at least one aeration valve comprises a plurality of runner blades of the turbine.

11. The method of claim 1, wherein the at least one aeration valve discharges air via through-blade aeration of the turbine.

12. The method of claim 1, wherein the at least one aeration valve discharges air via a passage within at least one runner blade of the turbine.

13. The method of claim 1, wherein the at least one aeration valve discharges air through a crown portion of the turbine.

14. The method of claim 1, wherein the at least one aeration valve discharges air via central aeration of the turbine.

15. The method of claim 1, wherein the at least one aeration valve discharges air via (a) through-blade aeration of the turbine and (b) central aeration of the turbine.

16. A computer-implemented method of closed-loop dissolved oxygen monitoring and control at a hydroelectric plant comprising:
using closed-loop control to regulate at least one aeration valve coupled to a turbine and at least one cone valve coupled to a water-retaining structure of the hydroelectric plant;
wherein a target parameter for the regulating is a dissolved oxygen concentration of water downstream of the hydroelectric plant.

17. The method of claim 16, wherein the dissolved oxygen concentration is at least 5.0 milligrams per liter.

18. The method of claim 16, wherein the closed-loop control comprises pattern recognition performed using a neural network.

19. The method of claim 18, wherein the pattern recognition comprises at least one machine learning algorithm.

20. The method of claim 16, wherein the closed-loop control is used to set a degree of opening the at least one aeration valve.

21. The method of claim 16, wherein the closed-loop control is used to set a degree of opening the at least one cone valve.

22. The method of claim 16, wherein the closed-loop control is provided with data inputs including at least one of:
(a) dissolved oxygen concentration, water level, and water temperature upstream of the hydroelectric plant;
(b) dissolved oxygen concentration, water level, and water temperature downstream of the hydroelectric plant;
(c) unit power output and quality;
(d) required dissolved oxygen concentration;
(e) atmospheric temperature and humidity; and
(f) time of day and day of year.

23. The method of claim 22, further comprising:
analyzing the data inputs using a four layer, four output neural network that outputs an optimal valve position of each of four intake air valves that minimizes efficiency loss while ensuring the hydroelectric plant satisfies the target parameter.

24. The method of claim 16, wherein the hydroelectric plant comprises a plurality of turbines and the closed-loop control is performed using a single neural network for each turbine.

25. The method of claim 16, wherein the hydroelectric plant comprises a plurality of turbines and the closed-loop control is performed using a single neural network for at least two of the plurality of turbines.

26. The method of claim 16, wherein the at least one aeration valve comprises a plurality of runner blades of the turbine.

27. The method of claim 16, wherein the at least one aeration valve discharges air via through-blade aeration of the turbine.

28. The method of claim 16, wherein the at least one aeration valve discharges air via a passage within at least one runner blade of the turbine.

29. The method of claim 16, wherein the at least one aeration valve discharges air through a crown portion of the turbine.

30. The method of claim 16, wherein the at least one aeration valve discharges air via central aeration of the turbine.

31. The method of claim 16, wherein the at least one aeration valve discharges air via (a) through-blade aeration of the turbine and (b) central aeration of the turbine.

32. The method of claim 16, wherein the at least one cone valve comprises a fixed cone valve.

33. The method of claim 16, wherein the at least one cone valve comprises a linear aerating valve.

34. A computer-implemented method of closed-loop dissolved oxygen monitoring and control at a hydroelectric plant comprising a turbine, the method comprising:
regulating at least one aeration valve coupled to a turbine by at least one machine learning algorithm;
wherein a target parameter for the regulating is a dissolved oxygen concentration of water downstream of the hydroelectric plant.

35. The method of claim 34, wherein the at least one machine learning algorithm comprises a neural network.

36. The medium of claim 35, wherein the dissolved oxygen concentration is at least 5.0 milligrams per liter.

37. A non-transitory computer-readable medium having computer readable instructions that, when executed by a processor of a computer, cause the computer to perform closed-loop dissolved oxygen monitoring and control at a hydroelectric plant comprising:
regulating at least one aeration valve coupled to a turbine using pattern recognition;
wherein a target parameter for the regulating is a dissolved oxygen concentration of water downstream of the hydroelectric plant.

38. The medium of claim 37, wherein the dissolved oxygen concentration is at least 5.0 milligrams per liter.

39. The medium of claim 37, wherein the pattern recognition is performed using a neural network.

40. A system comprising: a processor; memory including instructions that when executed by the processor, cause the system to perform closed-loop dissolved oxygen monitoring and control at a hydroelectric plant comprising:
regulating at least one aeration valve coupled to a turbine using pattern recognition;
wherein a target parameter for the regulating is a dissolved oxygen concentration of water downstream of the hydroelectric plant.

41. The system of claim 40, wherein the dissolved oxygen concentration is at least 5.0 milligrams per liter.

42. The system of claim 41, wherein the pattern recognition is performed using a neural network.
